(19) United States
(12) Patent Application Publication
(10) Pub. No.: US 2008/0005611 A1
(43) Pub. Date: Jan. 3, 2008

(54) Providing A Restore Operating System With New Or Updated Software Components

(75) Inventor: Sergey Solyanik, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/421,373

(22) Filed: May 31, 2006

(51) Int. Cl. G06F 11/00

(52) U.S. Cl. 714/6

(57) ABSTRACT

A method for creating a customized version of a bootable restore OS comprising determining the PC's software component needs, communicating the PC's software component needs to a server computer, and providing a bootable restore OS for the PC including the PC's software component needs.

### TECHNICAL FIELD

This description relates generally to backing up computer systems and more specifically to backing up computer systems from a network.

### BACKGROUND

Computers sometimes lose data, often due to disk errors or “crashes”. File-based or image-based backup solutions that store user's files on a network or removable media are often employed to protect users from data loss. Image backup is a type of the data protection in which backup software creates an exact, sector-by-sector copy of the hard drive. In the event of hardware failure or data corruption the copy is restored by copying sectors back to the hard drive. Such an image tends to be large and may be best stored on a server or the like.

To restore the hard drive after system failure, if the failure has destroyed the operating system (OS), it is necessary to boot from a device, such as a hard drive or a compact disk (CD), other than the system disk, since the operating system cannot function while the system disk is being overwritten by the process that restores the disk. For this reason, a typical backup solution provides a bootable CD with an alternative operating system (herein called the restore OS), which is used to run the application that restores the PC.

Backup services may be provided by a server computer to a client computer coupled to it. Such uses of a network to facilitate backup is typically facilitated by the increased prevalence of high capacity storage present in server computers. Such server computers may often be found in home, small business, and commercial settings. In such a setup the configuration of the client computer, including but not limited to the network adapter or storage drivers required during the restore process may affect delivery of the backup copy to a client or PC that is being restored.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a way for a server to provide a restore OS to a client computer that may include updated configuration information to facilitate restoration when new or updated hardware components have been added. Periodic checks are made to determine if the client computer configuration has been updated. If it has changed, the updated drivers and other software components are then incorporated into a restore OS. Finally the restore OS may be disposed onto a server hard drive or, in an alternative example, a CD.

Many of the attendant features may be more readily appreciated as the same becomes better understood by reference to the following detailed description considered in connection with the accompanying drawings.

### DESCRIPTION OF THE DRAWINGS

The present description may be better understood from the following detailed description read in light of the accompanying drawings, wherein:

FIG. 1 is a block diagram of a conventional computer network capable of producing a conventional restore OS image.

FIG. 2 is a block diagram of an example of a network capable of producing a restore OS image including new or updated software component information.

FIG. 3 is a block diagram showing further details of the network capable of producing a restore OS including new or updated software component information.

FIG. 4 is a flow diagram showing a process for creating a restore OS including new or updated software component information.

FIG. 5 is a block diagram showing a computing device capable of producing a restore OS image including new or updated software component information.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The examples below describe a backup system that uses a bootable CD for the restore operation. Although the present examples are described and illustrated herein as being implemented in a backup system that uses a bootable CD for restoring the computer, the system described is provided as an example and not a limitation. As those skilled in the art may appreciate, the present examples are suitable for application in a variety of different types of media in computer restoration systems. The term “computer readable media” may include one or more CDs, DVDs, hard drives, files on a network server, or equivalent. The term “computer readable media” may also include a plurality of items of one or more types.

In the examples described below a restore OS is created that includes new or updated hardware drivers that may have been added at a later time.

To update the drivers a server may automatically track PC hardware on its network, and incorporate drivers for the new hardware into a bootable restore CD, or equivalent, image. When a user needs to restore a PC, the user can burn the up-to-date bootable restore image to the CD which may have all the necessary hardware support.

Alternatively, the regeneration of restore CD image can be performed by a backup program alongside the process of creation of the backup in a setup where backup is stored on locally connected media such as plug-in USB hard drive or DVD+/−R/RW drives instead of a server. In the system without the server the networking drivers may not be collected, but the storage drivers would.

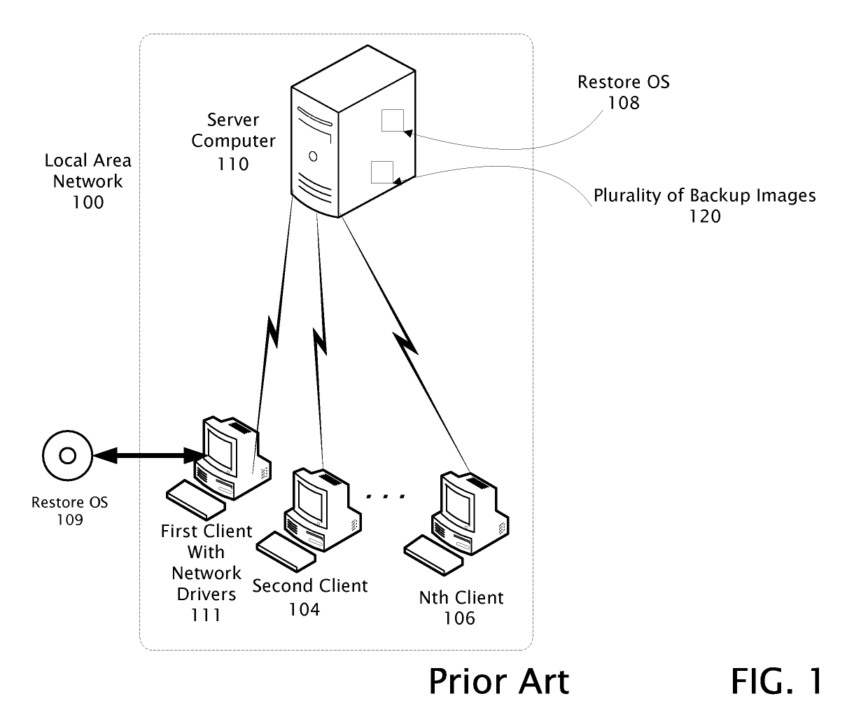

FIG. 1 is a block diagram of a conventional computer network capable of producing a conventional restore OS, typically disposed on a computer readable media such as a hard disk 108, or a CD 109. A local area network 100 may include a server computer 110, which is capable of producing a restore OS 108. Also included in the local area network 100, are a plurality of client computers 111, 104, and 106. The client computers 111, 104 and 106 are conventionally constructed. The client computers are typically coupled to a conventional server computer 110. In this local area network 100 a client computer 111, 104, or 106 may have its OS restored from a server 110, or by a restore OS disk 109 should the need arise. Additionally, a plurality of backup images may be disposed on server computer 110. There may be any number of back up images provided for the client computers 111, 104, 106. In a network with a restore OS 108 provided by a server 110, network information has typically been previously supplied to the server 110 for incorporation into any restore OS images that may be created. Typically drivers that are known when the restore software was created are available for incorporation. Drivers that have been added after creation of the software are typically left out which may cause problems in restoring the backup image.

A person skilled in the art would recognize that the local area network 100 may be coupled to other networks, by a wide area network that may be implemented through the internet, or an equivalent connection. Those skilled in the art would also realize that a number of other components may be present such as routers, switches and the like may also be present to facilitate networking.

To restore the disk by using a previously made backup the user typically must start up, or boot the computer into a separate operating environment which may be called a “restore OS”. A restore OS may include a version of an operating system such as Windows®, Linux®, or the like that is booted from a CD. An example of a restore OS is the Windows® PE (Pre-installation Environment). Once booted, software available in the restore OS operating environment may connect to a server computer to obtain the hard disk image to restore, or access backup data on locally connected USB hard drive or a DVD.

However, restoring from a server computer typically calls for coupling to the server via a network connection, and either type of backup system requires accessing the hard drive that is being restored. To facilitate the network connection, support for network hardware on the client PC is typically built into the restore OS. A pre-installation environment may call for the presence of the appropriate network drivers to boot over the network. Keeping the restore OS updated may be difficult because new versions of network chipsets get released every year, and they typically have new drivers that would not exist in older editions of the restore OS. Typically the restore OS is equipped with the drivers that were available at its software release date. Likewise, new versions of storage controllers come out frequently, and any older restore OS would typically not be able to access the storage medium on some newer PCs.

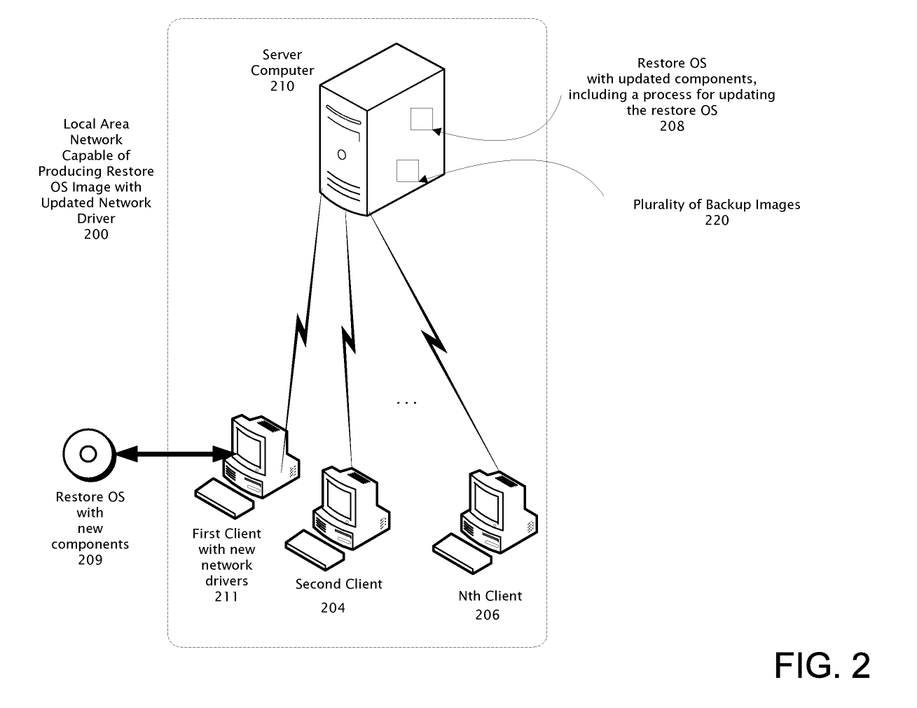

FIG. 2 is a block diagram of an example of a network capable of producing a restore OS image including new or updated software component information. In this and subsequent figures like reference numbers denote the same element and need not be described again.

A local area network 200 may include a server computer 210, which is capable of producing a restore OS with new or updated software component drivers including a process for updating the restore OS 208. Also included in the local area network 200, are a plurality of client computers 211, 204, and 206. The client computers 211, 204 and 206 are typically configured to facilitate the transfer of driver information to the server computer 210. The client computers are typically coupled to a server computer 210. In this local area network 200 a client computer 211, 204, or 206 may have its OS including updated network driver information restored by a server 210, or by a restore OS disk 209 should the need arise. In a network with a restore OS including updated network drivers provided by a server 210, network information has typically been previously supplied to the server 210 for incorporation into any restore OS that may be created by software agents running on clients 206-211. In this configuration a process for updating network drivers has been provided to allow for hardware updates. Drivers that have been added after creation of the software may be added to the restore OS, which may facilitate restoring the backup image.

In such a system a software agent running on the client periodically checks the client PC hardware for new and updated drivers. Once the drivers are detected, they are sent to the server. The software process running on the server adds them to the image of the restore OS. When it is time to restore the backup image to the computer, an up-to-date image of the restore OS is burned on a CD, which can then be used to boot the computer that needs to be restored from that CD.

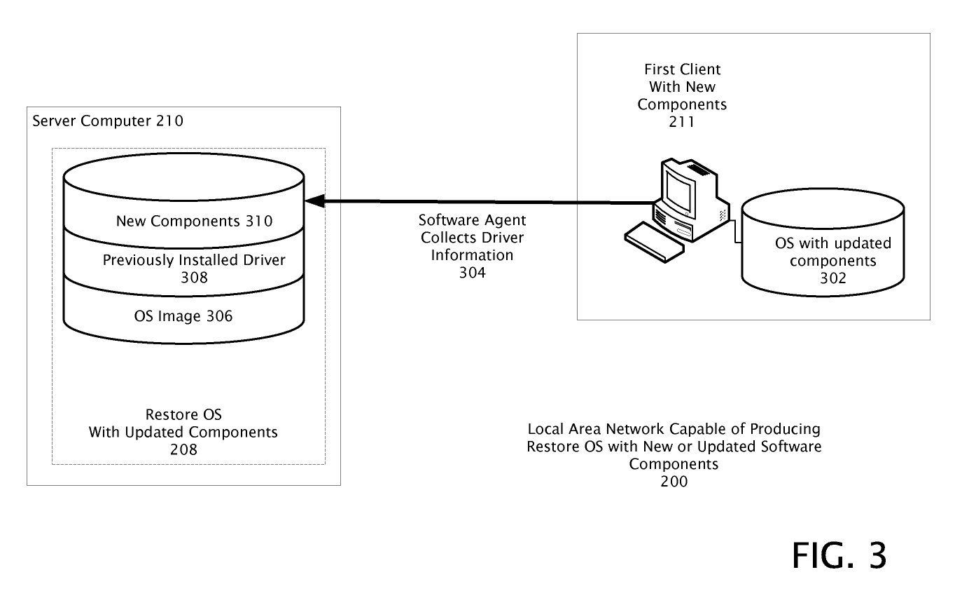

FIG. 3 is a block diagram showing further details of the network capable of producing a restore OS including new or updated software component information.

A server computer 210 may include a restore OS image with an updated network driver 208. The restore OS image typically includes the OS image 306, previously installed drivers 308, and any new drivers 310 that have been added after the release of the server software.

New drivers 310 are provided to the server computer 210, by a software agent 304 that runs on at least one client computer 211 in the network and periodically checks that computer for new or updated drivers. The first client computer with new drivers 211 typically includes a drive having an OS 302 disposed on it. The OS to be restored 302, may have drivers, such as network or storage drivers, that have been updated since the restore OS was produced. The software agent 304 monitors the client computer OS 302, and when driver updates occur, updates the restore OS 208 with the updated drivers. In another example, the software agent 304 may be notified by the OS with updated drivers 302 when drivers are updated. One skilled in the art would recognize that the software agent 304 may directly update the drivers, may indicate to the server that an updated driver is available, or use some other way to have the updated drivers added to the restore OS 208.

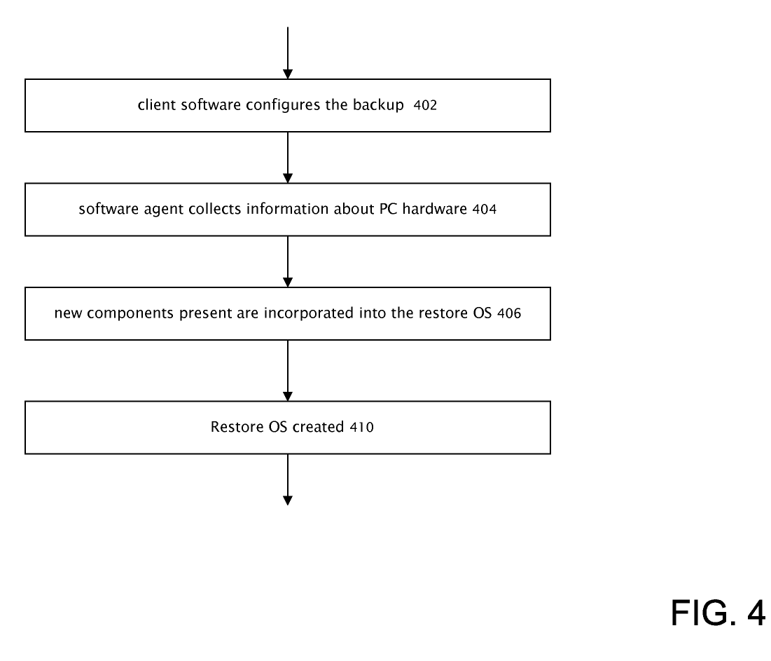

FIG. 4 is a flow diagram showing a process for creating a restore OS image including new or updated software component information. First, a backup is created 402. To create a restore OS including new or updated software component information, the hardware is tracked. A client-PC software agent tracks information about PC hardware 404 periodically or when the drivers are added or updated if a facility to track hardware changes exists in the operating system. This is accomplished by examining the client hardware to determine if any network or storage chipsets are present that are not presently supported by the server.

Then any new networking or storage drivers present are incorporated into the OS image that is stored on the server 406. A collection of scripts or software programs typically allow downloading and installation of new or updated software components into restore OS image 408.

A restore OS is then created 410. A program may be provided that compiles a CD image from the restore OS file data.

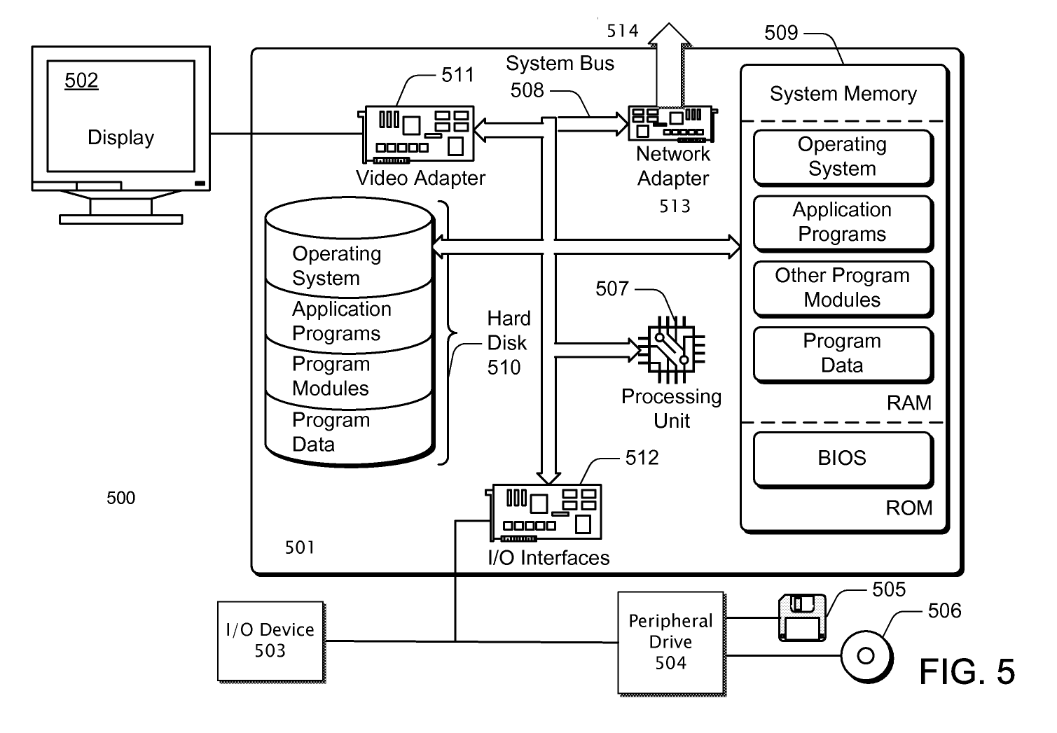

FIG. 5 is a block diagram showing a computing device capable of producing a restore OS image including new or updated software component information.

A restore OS may be disposed on hard disk 510, either on a server or a client PC. Alternatively a restore OS disk with the updated drivers may be created. In an alternative example an optional program may be provided to burn a CD using this image which could be run automatically from server or manually from a client.

The restore OS is maintained on the server as a collection of files. The software agent periodically interrogates the PCs on the network looking for changes in their hardware configuration. When it detects new hardware, it checks against the databases of the hardware already supported in the restore OS image. If the driver or other component is not supported, it tries to download drivers from an online service such as Windows update, or collect necessary files directly from PC, if the restore CD operating system can use device drivers of PC's operating system, as is the case where PC's OS is Windows and restore CD OS is Windows PE. If the drivers are not available from either the PC or the online service, it sends a message to server administrator asking it to upload the driver to the server's driver share manually. Once the driver has been obtained, it runs script to incorporate the new driver into the restore OS image. Finally, it runs the program to create a bootable CD image from the restore CD files.

The OS image then can be burned to a CD or CD-RW on the server if the server has CD-recorder drive, or on a client at user's request.

FIG. 5 illustrates an exemplary computing environment 500 in which the method for providing a restore OS with new or updated software components described in this application, may be implemented. Exemplary computing environment 500 is only one example of a computing system and is not intended to limit the examples described in this application to this particular computing environment.

For example the computing environment 500 can be implemented with numerous other general purpose or special purpose computing system configurations. Examples of well known computing systems, may include, but are not limited to, personal computers, hand-held or laptop devices, microprocessor-based systems, multiprocessor systems, set top boxes, gaming consoles, consumer electronics, cellular telephones, PDAs, and the like.

The computer 500 includes a general-purpose computing system in the form of a computing device 501. The components of computing device 501 can include one or more processors (including CPUs, GPUs, microprocessors and the like) 507, a system memory 509, and a system bus 508 that couples the various system components. Processor 507 processes various computer executable instructions, including those to control the operation of computing device 501 and to communicate with other electronic and computing devices (not shown). The system bus 508 represents any number of several types of bus structures, including a memory bus or memory controller, a peripheral bus, an accelerated graphics port, and a processor or local bus using any of a variety of bus architectures.

The system memory 509 includes computer-readable media in the form of volatile memory, such as random access memory (RAM), and/or non-volatile memory, such as read only memory (ROM). A basic input/output system (BIOS) is stored in ROM. RAM typically contains data and/or program modules that are immediately accessible to and/or presently operated on by one or more of the processors 507.

Mass storage devices 504 may be coupled to the computing device 501 or incorporated into the computing device by coupling to the bus. Such mass storage devices 504 may include a magnetic disk drive which reads from and writes to a removable, non volatile magnetic disk (e.g., a “floppy disk”) 505, or an optical disk drive that reads from and/or writes to a removable, non-volatile optical disk such as a CD ROM or the like 506. Computer readable media 505, 506 typically embody computer readable instructions, data structures, program modules and the like supplied on floppy disks, CDs, portable memory sticks and the like.

Any number of program modules can be stored on the hard disk 510, Mass storage device 504, ROM and/or RAM 5-9, including by way of example, an operating system, one or more application programs, other program modules, and program data. Each of such operating system, application programs, other program modules and program data (or some combination thereof) may include an embodiment of the systems and methods described herein.

A display device 502 can be connected to the system bus 508 via an interface, such as a video adapter 511. A user can interface with computing device 702 via any number of different input devices 503 such as a keyboard, pointing device, joystick, game pad, serial port, and/or the like. These and other input devices are connected to the processors 507 via input/output interfaces 512 that are coupled to the system bus 508, but may be connected by other interface and bus structures, such as a parallel port, game port, and/or a universal serial bus (USB).

Computing device 500 can operate in a networked environment using connections to one or more remote computers through one or more local area networks (LANs), wide area networks (WANs) and the like. The computing device 501 is connected to a network 514 via a network adapter 513 or alternatively by a modem, DSL, ISDN interface or the like.

Those skilled in the art may realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art may also realize that by utilizing conventional techniques known to those skilled in the art that all, or a portion of the software instructions may be carried out by a dedicated circuit, such as a DSP, programmable logic array, or the like.

1. A method for creating a customized version of a PC's bootable restore media comprising:
determining the PC's hardware;
transferring the PC's drivers to a server computer; and
incorporating the drivers into a bootable restore image which supports the PC's hardware.

2. The method for creating a customized version of a PCs bootable restore media of claim 1, in which the PCs hardware is detected by checking the PC's operating system for the presence of new drivers.

3. The method for creating a customized version of a PC's OS of claim 1, in which the bootable restore media image includes software components not originally incorporated into bootable restore CD image originally provided by a manufacturer.

4. The method for creating a customized version of a PC's OS of claim 1, in which the bootable restore media image includes new drivers, previously provided installed drivers, and an operating system.

5. The method for creating a customized version of a PCs OS of claim 1, in which the PCs hardware and device drivers are determined by a software agent.

6. The method for creating a customized version of a PC's OS of claim 1, further comprising disposing a bootable restore OS for the PC including the PCs software components on computer readable media.

7. The method for creating a customized version of a PC's OS of claim 6, in which the computer readable media is a compact disk.

8. The method for creating a customized version of a PCs OS of claim 6, in which the PCs hardware configuration is determined by checking PC operating environment for the presence of a new driver.

9. The method for creating a customized version of a bootable restore media of claim 6, in which the bootable restore media includes drivers not originally incorporated in a bootable restore media provided by backup software manufacturer.

10. The method for creating a customized version of a PC's OS of claim 6, in which the backup includes one or more new drivers, one or more previously installed drivers, and an operating system.

11. The method for creating a customized version of a PC's bootable restore OS of claim 6, in which the PC's hardware is determined by a software agent.

12. A computer network providing a bootable restore OS, the computer network comprising:
a software agent to collect a new driver; and
a plurality of scripts to install the new driver into a restore OS with updated driver information.

13. The computer network providing the bootable restore OS of claim 12, further comprising a utility to transfer the OS with updated driver information to a computer readable media.

14. The computer network providing the bootable restore OS of claim 12, in which the computer readable media is a compact disk.

15. The computer network providing the bootable restore OS of claim 12, in which the restore OS with updated driver information is disposed on a server for later transfer to a client computer being restored.

16. The computer network providing the bootable restore OS of claim 12, in which the transfer is provided by a network connection

17. Computer readable media including executable instructions stored thereon that, when executed, create an operating system with updated drivers, comprising:
an operating system;
a plurality of previously installed drivers; and
a plurality of newly installed drivers to facilitate restoration of a client computer by delivering the operating system over a network to the client computer, or recording it to the hard drive.

18. The computer readable media including executable instructions stored thereon that, when executed, create an operating system with updated drivers of claim 17, further comprising a software agent to deliver the newly installed driver.

19. The computer readable media including executable instructions stored thereon that, when executed, create an operating system with updated drivers of claim 17, in which the newly installed driver and the operating system image are combined to produce a restore OS image.

20. The computer readable media including executable instructions stored thereon that, when executed, create an operating system with updated drivers of claim 19, in which the combination is accomplished by scripts.
